(19) United States
(12) Patent Application Publication
(10) Pub. No.: US 2023/0153153 A1
(43) Pub. Date: May 18, 2023

(54) TASK PROCESSING METHOD AND APPARATUS

(71) Applicant: MONTAGE TECHNOLOGY CO., LTD., Shanghai (CN)

(72) Inventors: Yanjia KE, Shanghai (CN); Zhaohui DU, Shanghai (CN); Wenbo QU, Shanghai (CN)

(21) Appl. No.: 18/056,242

(22) Filed: Nov. 16, 2022

(30) Foreign Application Priority Data
Nov. 17, 2021 (CN) 202111363169X

(51) Int. Cl. G06F 9/48; G06F 9/445; G06F 9/30

(52) U.S. Cl. CPC G06F 9/4881; G06F 9/44505; G06F 9/3004

(57) ABSTRACT

A task processing apparatus and a task processing method are provided. The task processing apparatus is coupled to a host apparatus, and includes: a controller configured to query whether there is a data processing task to be executed and trigger execution of the data processing task; at least one data processing engine configured to process operation data corresponding to the data processing task according to a configured working mode, and generate a data processing result; and at least one scheduler configured to: receive a task descriptor of the data processing task from the host apparatus; configure the working mode of the data processing engine based on the task descriptor; control transmission of the operation data corresponding to the data processing task from the host apparatus to the data processing engine; and control transmission of the data processing result from the data processing engine to the host apparatus.

### CROSS REFERENCE TO RELATED APPLICATIONS

This application claims priority to Chinese patent application No. 202111363169.X filed on Nov. 17, 2021, the entire content of which is incorporated herein by reference.

### TECHNICAL FIELD

This application relates to the field of computer, and in particular, to a task processing method and a task processing apparatus.

### BACKGROUND

With the development of computer and internet technology, the data processing speed of computer is required to be higher and higher in many application fields. For example, in a data center, a computing capability of a general-purpose computing platform needs to be increased to meet large-scale concurrent data computing requests from users. However, the computing capability of the general-purpose computing platform usually increases linearly, while the data computing requests from uses increase exponentially. That is, the two increases do not match each other. In addition, with the rise of new services such as mobile internet, mobile computing and cloud storage, more and more new algorithms are required. However, the general-purpose computing platform has not been effectively optimized for these new algorithms, and is not flexible enough to meet diverse user needs. In order to solve the above problems, acceleration cards are used to assist the general-purpose computing platform to perform operations in the prior art. The acceleration cards may use computing engines such as Application-Specific Integrated Circuits (ASICs), Graphics Processing Units (GPUs), Field Programmable Gate Arrays (FPGAs), or Digital Signal Processors (DSPs) to perform operations on specific tasks, thereby improving computing efficiency.

However, the existing acceleration card has a performance bottleneck in the multi-task scenario, and cannot fully utilize the performance of all computing engines.

### SUMMARY

An objective of the present application is to provide a task processing method and a task processing apparatus, which can improve the efficiency of task processing in a concurrent multi-task scenario.

In an aspect of the application, a task processing apparatus is provided. The task processing apparatus may be coupled to a host apparatus via a communication interface to perform task and data interactions with the host apparatus, and may include: a controller configured to query whether there is a data processing task to be executed in the task processing apparatus and trigger execution of the data processing task if the data processing task exists; at least one data processing engine configured to process operation data corresponding to the data processing task according to a configured working mode, and generate a data processing result; and at least one scheduler configured to: receive a task descriptor of the data processing task from the host apparatus via the communication interface; configure the working mode of the data processing engine based on the task descriptor after the execution of the data processing task is triggered; control transmission of the operation data corresponding to the data processing task from the host apparatus to the data processing engine via the communication interface; and control transmission of the data processing result from the data processing engine to the host apparatus via the communication interface, after the data processing engine has completed the processing of the operation data and generated the data processing result.

In another aspect of the application, a task processing system is provided. The task processing system may include: a host apparatus; and at least one task processing apparatus coupled to the host apparatus via a communication interface to perform task and data interaction with the host apparatus; wherein the host apparatus is configured to: receive a data processing task from a user program executed by the host apparatus; allocate the data processing task to a virtual function queue and generate a task descriptor corresponding to the data processing task according to a type of the data processing task; transmit the task descriptor to the at least one task processing apparatus for execution; and receive from the at least one task processing apparatus a data processing result generated after operation data is processed; wherein the task processing apparatus includes: a controller configured to query whether there is a data processing task to be executed in the task processing apparatus and trigger execution of the data processing task if the data processing task exists; at least one data processing engine configured to process operation data corresponding to the data processing task according to a configured working mode, and generate a data processing result; and at least one scheduler configured to: receive a task descriptor of the data processing task from the host apparatus via the communication interface; configure the working mode of the data processing engine based on the task descriptor after the execution of the data processing task is triggered; control transmission of the operation data corresponding to the data processing task from the host apparatus to the data processing engine via the communication interface; and control transmission of the data processing result from the data processing engine to the host apparatus via the communication interface, after the data processing engine has completed the processing of the operation data and generated the data processing result.

In still another aspect of the application, a task processing method is provided. The method may be executable by a scheduler in a task processing apparatus and include: receiving a task descriptor of a data processing task from a host apparatus via a communication interface; configuring a working mode of the data processing engine based on the task descriptor after the execution of the data processing task is triggered; controlling transmission of operation data corresponding to the data processing task from the host apparatus to the data processing engine via the communication interface; and controlling transmission of a data processing result from the data processing engine to the host apparatus via the communication interface, after the data processing engine has completed the processing of the operation data and generated the data processing result.

In the technical solutions of the present application, the task processing apparatus includes a scheduler besides a controller. The scheduler can take most operations performed by the controller in the conventional solution, such as receiving the task descriptor, semantic parsing of the task descriptor, configuring the working mode of the data processing engine, and controlling transmissions of the operation data and the data processing result. The load of the controller in the present application can be greatly reduced, thereby improving the performance of the task processing apparatus in multi-task scenarios.

In addition, a task descriptor is introduced in the task processing apparatus of the technical solution of the present application. Thus, the data processing tasks supported by the task processing apparatus can be abstracted into a task descriptor with a preset format, which is beneficial for the scheduler to independently and efficiently parse the information about the data processing task and improve the parsing efficiency.

The foregoing is a summary of the present application and may be simplified, summarized, or omitted in detail, so that a person skilled in the art shall recognize that this section is merely illustrative and is not intended to limit the scope of the application in any way. This summary is neither intended to define key features or essential features of the claimed subject matter, nor intended to be used as an aid in determining the scope of the claimed subject matter.

### BRIEF DESCRIPTION OF THE DRAWINGS

The abovementioned and other features of the present application will be more fully understood from the following specification and the appended claims, taken in conjunction with the drawings. It can be understood that these drawings depict several embodiments of the present application and therefore should not be considered as limiting the scope of the present application. By applying the drawings, the present application will be described more clearly and in detail.

FIG. 1 is a block diagram illustrating a task processing apparatus according to an embodiment of the present application;

FIG. 2 is a block diagram illustrating a task processing apparatus and a host apparatus according to an embodiment of the present application;

FIG. 3 is a block diagram illustrating a task processing apparatus and a host apparatus according to an embodiment of the present application;

FIG. 4 illustrates fields of a task descriptor according to an embodiment of the present application;

FIG. 5 illustrates various fields indicating a data processing task of the task descriptor in FIG. 4; and

FIG. 6 is a flowchart illustrating interactions between a task processing apparatus and a host apparatus according to an embodiment of the present application.

### DETAILED DESCRIPTION

The following detailed description refers to the drawings that form a part hereof. In the drawings, similar symbols generally identify similar components, unless context dictates otherwise. The illustrative embodiments described in the description, drawings, and claims are not intended to limit. Other embodiments may be utilized and other changes may be made without departing from the spirit or scope of the subject matter of the present application. It can be understood that numerous different configurations, alternatives, combinations and designs may be made to various aspects of the present application which are generally described and illustrated in the drawings in the application, and that all of which are expressly formed as part of the application.

In the conventional solution of using the acceleration card to assist the general-purpose computing platform to perform operations, the controller at the acceleration card side may be involved in various operations during execution of single task, such as reception and parse of operation data, configuration of the working mode of the data processing engine, packaging and output of the operation result, etc. When multiple tasks are concurrent, the controller needs to perform the above multiple operations for each task, making the controller overloaded and unable to respond to subsequent unprocessed tasks in time, and consequently increasing the average execution time for each task. Meanwhile, the controller needs to process each task in sequence. Even if there are other idle data processing engines in the acceleration card, as the controller cannot allocate tasks to these idle data processing engines in time and the idle data processing engines cannot assist in processing unprocessed tasks, the unprocessed tasks continue to increase. It can be seen from the above that the controller is involved in too many operations during the execution of each task, and it will become a bottleneck that potentially limits the overall performance (for example, throughput and latency) of the accelerator card in the concurrent multi-task scenario.

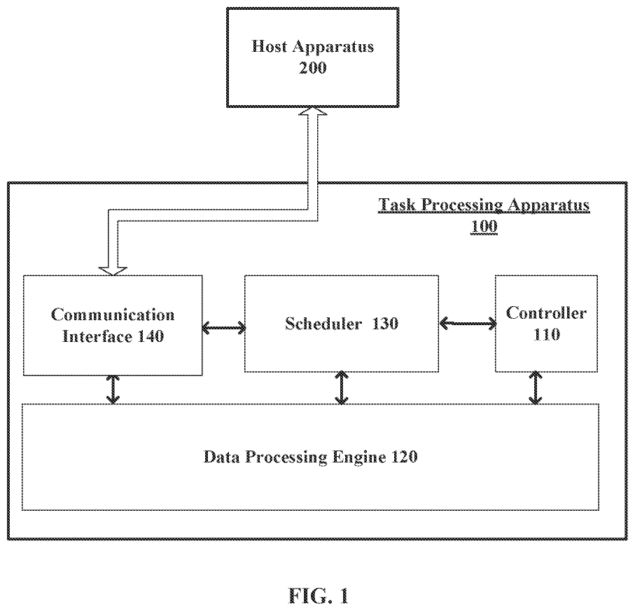

In order to address at least one of the above problems, a task processing apparatus is provided in an aspect of the present application. In the task processing apparatus, the occupation of the controller for executing each task can be reduced, so that concurrent multiple tasks can be effectively executed. Referring to FIG. 1, a block diagram illustrating a task processing apparatus 100 is shown according to an embodiment of the present application.

As shown in FIG. 1, the task processing apparatus 100 includes a controller 110, at least one data processing engine 120 and at least one scheduler 130. The task processing apparatus 100 is coupled to a host apparatus 200 via a communication interface 140 to perform task and data interactions with the host apparatus 200. The controller 110 is configured to query whether there is a data processing task to be executed in the task processing apparatus 100, and trigger execution of the data processing task if the data processing task to be executed exists.

The data processing engine 120 is configured to process operation data corresponding to the data processing task according to a configured working mode, and generate a data processing result. In some embodiments, the data processing engine 120 may be a hardware, a software, a firmware, or a combination thereof, having specific computing functions. For example, the data processing engine 120 may be implemented as an ASIC circuit, or an FPGA circuit. The scheduler 130 is configured to receive a task descriptor of the data processing task from the host apparatus 200 via the communication interface 140, request to obtain a data packet which includes an operation instruction and relates to the data processing task based on the received task descriptor, and configure the working mode of the data processing engine 120 based on the task descriptor after the execution of the data processing task is triggered, The scheduler 130 is further configured to control transmission of the operation data corresponding to the data processing task from the host apparatus 200 to the data processing engine 120 via the communication interface 140, and control transmission of a data processing result from the data processing engine 120 to the host apparatus 200 via the communication interface 140, after the data processing engine 120 has completed the processing of the operation data and generated the data processing result.

As can be seen, the scheduler 130 in the above task processing apparatus 100 takes most loads of the controller in the conventional solution, such as operations of receiving the task descriptor, semantic parsing of the task descriptor, configuring the working mode of the data processing engine 120, and controlling transmissions of the operation data and the data processing result. In this way, during execution of a data processing task, the controller 110 only needs to query whether there is a data processing task to be executed, and trigger the execution of the data processing task, thereby significantly reducing the load of the controller 110 and improving the performance of the task processing apparatus 100 in multi-task scenarios.

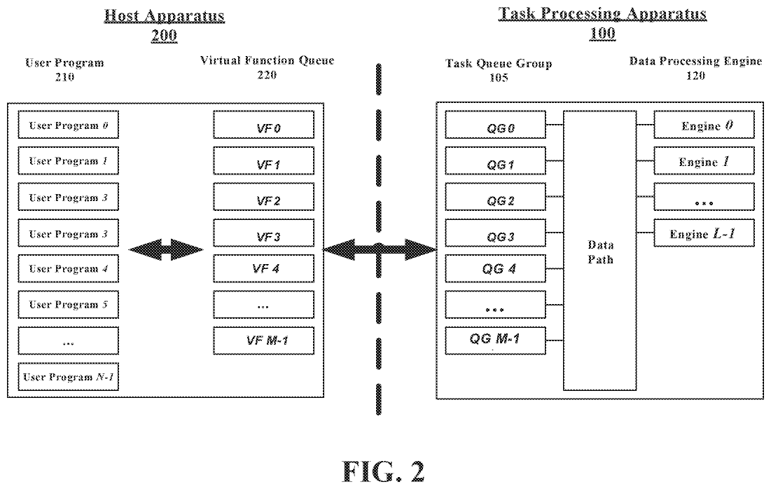

In some embodiments, the host apparatus 200 may be a server in a data center that supports virtualization technology. For example, as shown in FIG. 2, one or more user programs 210 (for example, the N user programs shown in FIG. 2) may run on the host apparatus 200, and may be allocated to different remote users or local users. The host apparatus 200 may receive data processing tasks from the user programs 210. After receiving the data processing tasks, the host apparatus 200 may allocate the data processing tasks to one or more virtual function queues 220 (for example, the M virtual function queues from VF 0 to VF M−1 as shown in FIG. 2) according to the types of the data processing tasks, and generate task descriptors corresponding to the data processing tasks. In some embodiments, each task descriptor at least contains information indicative of: a type of a data processing task, a storage location of operation data related to a data processing task, and a storage location of data processing result generated after the processing of a data processing task is completed. The task processing apparatus 100 has one or more task queue groups 105 (for example, M task queue groups from QG 0 to QG M−1 as shown in FIG. 2) which have a same number as and correspond to the virtual function queues 220 of the host apparatus 200. The task queue groups 105 are configured to buffer different types of data processing tasks from the host apparatus 200. After the host apparatus 200 transmits the task descriptors to the task processing apparatus 100, the task processing apparatus 100 may buffer the data processing tasks in corresponding task queue groups based on the information of the types of the data processing tasks. Then, the scheduler may be configured to select an appropriate data processing engine from the one or more data processing engines 120 (for example, the L data processing engines from 0 to L−1 as shown in FIG. 2) to execute a data processing task according to the information of the type of the data processing task. The task processing apparatus 100 may return a data processing result to the host apparatus 200 after the data processing engine 120 has completed the processing of the operation data corresponding to the data processing task and generated the data processing result. In the above examples, N, M, and L are all integers greater than 1, and are equal or unequal to each other.

In some embodiments, the task processing apparatus 100 may be implemented as an express card or an acceleration card in the host apparatus 200. For example, the task processing apparatus 100 may be deployed on a chassis of the host apparatus 200 and interconnected with the host apparatus 200 via the communication interface 140. The communication interface 140 may be a PCIe interface or other suitable communication interface. The host apparatus 200 and the task processing apparatus 100 form a master-slave architecture. The host apparatus 200 transmits data processing tasks to the task processing apparatus 100 through the communication interface 140, and the task processing apparatus 100 completes the execution of the data processing tasks and returns the processing results to the host apparatus 200. In some embodiments, a plurality of task processing apparatuses 100 having the same or different functions may be connected to the host apparatus 200 based on different application scenarios or computing requirements, so as to process multiple data processing tasks in parallel to further improve the task execution efficiency.

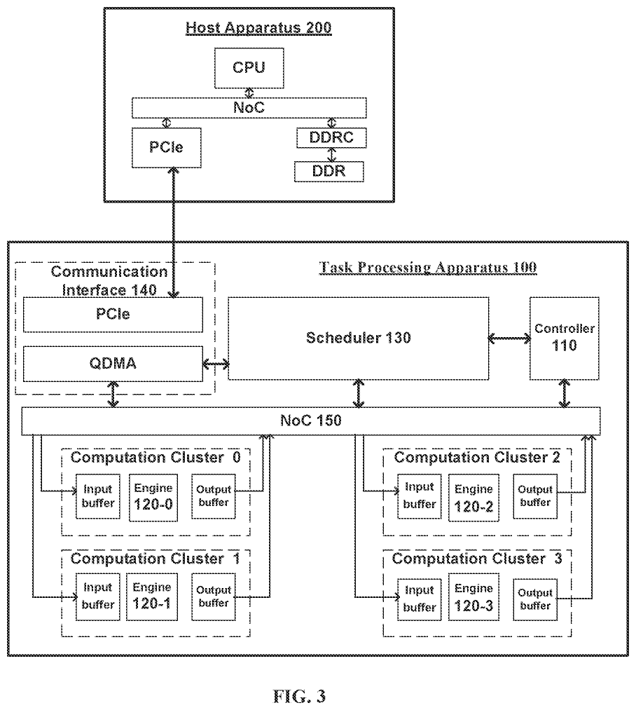

The task processing apparatus of the present application will be further described below with reference to FIG. 3. FIG. 3 is a schematic block diagram of the task processing apparatus 100 and the host apparatus 200 according to an embodiment of the present application.

Referring to FIG. 3. the task processing apparatus 100 is coupled with the host apparatus 200 via the communication interface 140. The task processing apparatus 100 includes a controller 110, at least one data processing engine 120 and at least one scheduler 130. The controller 110, the at least one data processing engine 120 and the at least one scheduler 130 are directly or indirectly electrically connected with each other through a network-on-chip 150 to perform data transmissions or interactions.

In an embodiment, the communication interface 140 includes a peripheral component interconnect express (PCIe) interface and a queue direct memory access (QDMA) controller. PCIe is a high-speed serial computer expansion bus standard, and QDMA is a queue fast-direct memory access technology, which allows hardware devices with different speeds to interact with each other. During data transmission, the QDMA controller can directly manage the bus without relying on a large number of interruption loads of the controller, such that the load of the controller can be greatly reduced. In the example of FIG. 3. the PCIe interface of the task processing apparatus 100 is coupled with the PCIe interface of the host apparatus 200 to perform task and data interactions between the task processing apparatus 100 and the host apparatus 200. It could be understood by those skilled in the art that, other types of communication interfaces may also be used for coupling the task processing apparatus 100 with the host apparatus 200 in other embodiments, such as a PCI interface or a DMA controller, which will not be elaborated herein.

In the example shown in FIG. 3. the task processing apparatus 100 includes four data processing engines 120-0, 120-1, 120-2 and 120-3. The data processing engine 120 may be a hardware circuit, and the hardware circuit may be optimized for different data processing algorithms to meet different application requirements. Specifically, the data processing task may include operation data and operation instructions for indicating operations performed on the operation data, such as encrypting or decrypting specific data, etc. Different data processing tasks may include different operation data or different operation instructions. One or more data processing engines 120 in the task processing apparatus 100 may be optimized for algorithms (for example, encryption or decryption algorithms) involved in the operation instructions. The data processing engine 120 may include one or more of: a field programmable gate array (FPGA), a graphics processing unit (GPU), a digital signal processor (DSP), an application specific integrated circuit (ASIC), a discrete device, or a transistor logic device. The data processing engine can process the operation data corresponding to the data processing task from the host apparatus 200 according to the configured working mode, and generate a data processing result. In addition, in the example shown in FIG. 3. each data processing engine has its respective input buffer and output buffer, wherein the input buffer is used for buffering the operation data, and the output buffer is used for buffering the data processing result. Each data processing engine and its respective input buffer and output buffer form an independent computation cluster. It could be understood by those skilled in the art that, the task processing apparatus 100 may also have other numbers of data processing engines (for example, 8, 16, 32, 64, etc.), and multiple data processing engines may share a same input buffer and/or a same output buffer.

In some embodiments, the scheduler 130 is configured to receive the task descriptor of the data processing task from the host apparatus 200 via the communication interface 140. In some embodiments, the task descriptor may have a preset format and at least contain information indicative of: a type of a data processing task, a storage location of operation data related to a data processing task, and a storage location of a data processing result generated after the processing of a data processing task is completed. In some embodiments, the task descriptor may further contain information indicative of an operation command required for executing the task, such as a name or a storage address of the operation command. After receiving the task descriptor, the scheduler 130 may pre-parse the task descriptor to obtain the information of the operation command. The above pre-parsing refers to parsing only parts of content or specific fields of the task descriptor, rather than parsing all fields of the task descriptor. The scheduler 130 may obtain a data packet containing the operation command from the host apparatus 200 based on the information of the operation command, and unpack the data packet to obtain the operation command after the data processing task corresponding to the task descriptor is triggered to be executed. In addition, the scheduler 130 may also perform a complete semantic parse on the task descriptor, so as to obtain the information of the type of the data processing task, the storage location of the operation data related to the data processing task, and the storage location of the data processing result generated after the data processing task is completed. Then, the scheduler 130 may configure the working mode of the data processing engine 120 according to the information of the type of the data processing task, and instruct the data processing engine 120 to start. The scheduler 130 may also control the acquisition of the operation data from the memory of the host apparatus 200 based on the information of the storage location of the operation data, and control transmission of the data processing result to the memory of the host apparatus 200 based on the information of the storage location of the data processing result. In some embodiments, when the task processing apparatus 100 includes a plurality of data processing engines, the scheduler 130 may further select a specific data processing engine from the plurality of data processing engines according to the information of the type of the data processing task in the task descriptor to execute the data processing task corresponding to the task descriptor. The scheduler 130 may preferably be implemented as a hardware circuit (for example, a FPGA or ASIC circuit), so as to simplify the data interaction between the host apparatus 200 and the task processing apparatus 100 and reduce the load of the controller 120 in the task processing apparatus 100.

In some embodiments, the controller 110 may be a general-purpose processor, which is configured to query whether there is a data processing task to be executed in the task processing apparatus 100, and trigger the execution of the data processing task when the data processing task to be executed exists. In some embodiments, the task processing apparatus 100 may include multiple schedulers 130, thereby allowing the multiple schedulers to schedule multiple user tasks in parallel. In this case, the controller 110 may poll the multiple schedulers to query whether there is a data processing task to be executed in the multiple schedulers, and when it is determined that there is a data processing task to be executed in a certain scheduler, the execution of the data processing task is triggered accordingly.

It should be noted that, although the communication interface 140 is in the task processing apparatus 100 in the embodiments shown in FIG. 1 and FIG. 3, the communication interface 140 may be a module independent of or outside of the task processing apparatus 100 in other embodiments.

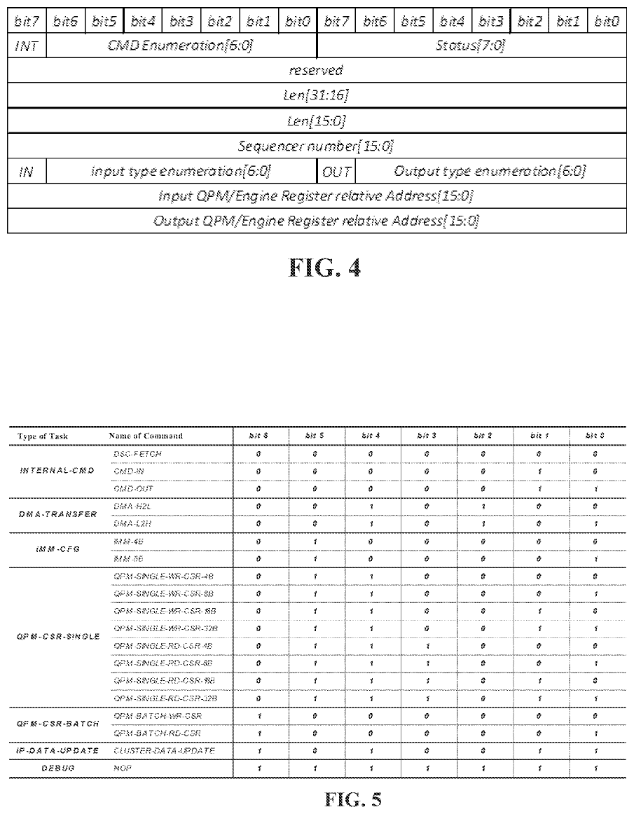

Referring to FIG. 4, different fields of a task descriptor is shown according to an embodiment of the present application. As shown in FIG. 4, the task descriptor consists of eight 16-bit characters, in which the first character includes a 1-bit “INT” field, a 7-bit “CMD Enumeration” field, and an 8-bit “Status” field. In some embodiments, if the “INT” field is set to be valid, it is indicated that the data processing engine 120 needs to send an interrupt request to the scheduler 130 after the data processing task is completed. Otherwise, if the “INT” field is set to be invalid, the scheduler 130 polls the data processing engines 120 to determine whether the data processing engine 120 completes the data processing task. In some embodiments, the “CMD Enumeration” field may indicate a type of the data processing task and a name of the command executed in the task. In some embodiments, the “Status” field may indicate a status of the current data processing task, and its initial value is 0. When the data processing engine 120 finishes the data processing task, or when an error occurs during execution the data processing task, the value of the “Status” field may be set to other values to indicate that the task is completed, or an error occurs in the execution of the task. The second character is a reserved field for function expansion. The third and fourth characters are upper 16 bits and lower 16 bits of a 32-bit length “Len” field, respectively. The “Len” field can be used to store some other commands that relates to the data processing task and cannot be stored in the “CMD Enumeration” field. The fifth character is a “Sequencer number” field with a length of 16 bits, which is used to indicate a sequencer number of the data processing task provided by the user. The sixth character includes a 1-bit “IN” field, a 7-bit “Input type enumeration” field, a 1-bit “OUT” field, and a 7-bit “Output type enumeration” field. In some embodiments, if the execution of the data processing task needs to obtain operation data from an external memory, the “IN” field is set to 1. Otherwise, the “IN” field is set to 0. In the case that there is no need to obtain the operation data from the external memory, the “Input type enumeration” field is used to indicate the type of operation data acquired from the host apparatus 200. In some embodiments, if the execution of the data processing task needs to output data to the external memory, the “OUT” field is set to 1. Otherwise, the “OUT” field is set to 0. In the case that there is no need to output data to the external memory, the “Output type enumeration” field is used to indicate a type of the data processing result returned to the host apparatus 200. The seventh character is an “Input QPM/Engine Register relative Address” field with a length of 16 bits, which is used to indicate an offset address of the operation data in the memory (QPM) of the host apparatus 200, or indicate a relative address of the operation data in the input buffer of the data processing engine 120. The eighth character is an “Output QPM/Engine Register relative Address” field with a length of 16 bits, which is used to indicate an offset address of the data processing result in the memory of the host apparatus 200, or indicate a relative address of the data processing result in the output buffer of the data processing engine 120.

Further referring to FIG. 5, different configurations of the “CMD Enumeration” filed, which is included in the task descriptor of FIG. 4 for indicating the type of data processing task, are shown. As described above, the “CMD Enumeration” field is a 7-bit binary number and can indicate at most 2⁷ different task types, but only 19 possible situations are listed in FIG. 5. For example, the value of the “CMD Enumeration” field may be “0010100” or “0010101”, both of which indicate that the data processing task is a DMA type data transmission. Specifically, “0010100” indicates that the specific command involved in the data transmission is “DMA-H2L” (which indicates that the related data is transmitted from a Host side (i.e., a master side, for example, the host apparatus 200) to a Local side (i.e., a slave side, for example, the task processing apparatus 100) by means of direct memory access (DMA)), while “0010100” indicates that the specific command involved in the data transmission is “DMA-L2H” (which indicates that the related data is transmitted from the Local side to the Host side by means of DMA). It could be understood that the corresponding relationship between values of the “CMD Enumeration” field and different commands can be defined by the user, and will not be elaborated herein.

The task descriptor of the present application has been described in detail above in conjunction with FIG. 4 and FIG. 5. However, the above detailed description is only an example, rather than a limitation of the solution of the present application. Those skilled in the art can design other different types of task descriptors in combination with specific application scenarios and requirements.

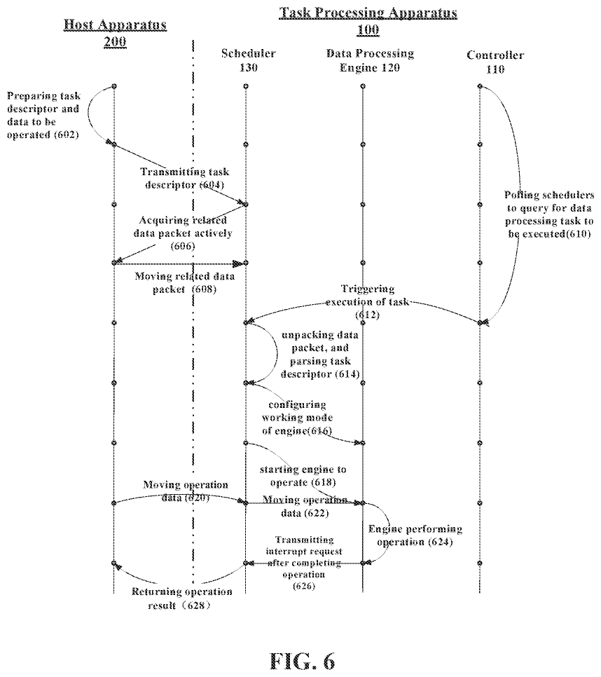

Referring to FIG. 6. a flowchart of interaction between the task processing apparatus 100 and the host apparatus 200 is illustrated according to an embodiment of the present application.

Referring to FIG. 6, the host apparatus 200 may prepare a task descriptor and data to be operated (602). After preparing the task descriptor and the data to be operated, the host apparatus 200 transmits the task descriptor to the scheduler 130 of the task processing apparatus 100 (604). After receiving the task descriptor, the task processing apparatus 100 may pre-parse the task descriptor to obtain information of a data packet related to execution of the task, acquire the related data packet from the host apparatus 200 actively (606), and control transmission of the related data packet from the host apparatus 200 to the task processing apparatus 100 (608). In some embodiments, the information of the related data packet at least includes information of an operation command required for executing the task, such as a name or a storage address of the operation command, such that the task processing apparatus 100 can acquire the operation command required for executing the task based on the information. It could be understood by those skilled in the art that, the above related data packet may also include other information related to the execution of the task in addition to the operation command.

Continuing referring to FIG. 6. the controller 110 of the task processing apparatus 100 may be configured to poll the scheduler 130 to query whether there is a data processing task to be executed (610). In some embodiments, after receiving the operation command required for executing the task, the scheduler 130 will set an identifier to indicate that there is currently a task to be executed; and when the controller 110 polls this scheduler, the controller 110 can determine whether there is a data processing task to be executed based on the identifier. If determining that there is a task to be executed in the scheduler 130, the controller 110 may trigger the scheduler 130 to execute the task (612). The scheduler 130 may unpack the acquired related data packet, and perform semantic parse on the task descriptor (614), so as to obtain the operation command required for executing the task from the data packet, and obtain information of the type of the task, the storage location of the operation data related to the task, and the storage location of the data processing result generated after the task processing is completed. Thereafter, the scheduler 130 may configure the data processing engine 120 according to the information of the type of the task (616), and start the data processing engine 120 to perform the operation (618).

Next, the scheduler 130 may transmit the operation data from the host apparatus 200 to the scheduler 130 based on the information of the storage location of the operation data (620), and then move the operation data into the data processing engine 120 (for example, into the input buffer of the data processing engine 120) via the scheduler 130 (622). In other embodiments, the scheduler 130 may also directly control the transmission of the operation data from the host apparatus 200 to the data processing engine 120 based on the information of the storage location of the operation data, without forwarding the operation data through the scheduler 130. After obtaining the operation data, the data processing engine 120 may start to execute the data processing task (624), and send an interrupt request to the scheduler 130 (626) after the task execution is completed. The scheduler 130 may respond to the interrupt request from the data processing engine 120 and control transmission of the data processing result from the data processing engine 120 to the host apparatus 200 (628), thereby completing the execution of the data processing task.

More details about the task processing apparatus 100 and the host apparatus 200 may refer to structures of the task processing apparatus 100 and the host apparatus 200 described above, and will not be elaborated herein.

It should be noted that, the apparatus embodiments described above are only for the purpose of illustration. For example, the division of the units is only a logical function division, and there may be other divisions in actual implementations. For example, multiple units or components may be combined or may be integrate into another system, or some features can be omitted or not implemented. In addition, the displayed or discussed mutual coupling, direct coupling or communication connection may be indirect coupling or indirect communication connection through some interfaces, devices or units in electrical or other forms. The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments. In addition, the steps of the above-described methods can be omitted or added as required. In addition, multiple steps can be executed simultaneously or sequentially. When multiple different steps are executed sequentially, the execution order may be different in different embodiments.

Those skilled in the art will be able to understand and implement other changes to the disclosed embodiments by studying the specification, disclosure, drawings and appended claims. In the claims, the wordings “comprise”, “comprising”, “include” and “including” do not exclude other elements and steps, and the wordings “a” and “an” do not exclude the plural. In the practical application of the present application, one component may perform the functions of a plurality of technical features cited in the claims. Any reference numeral in the claims should not be construed as limit to the scope.

What is claimed is:

1. A task processing apparatus, the task processing apparatus being coupled to a host apparatus via a communication interface to perform task and data interactions with the host apparatus, and the task processing apparatus comprising:
a controller configured to query whether there is a data processing task to be executed in the task processing apparatus, and trigger execution of the data processing task if the data processing task exists;
at least one data processing engine configured to process operation data corresponding to the data processing task according to a configured working mode, and generate a data processing result; and
at least one scheduler configured to:
receive a task descriptor of the data processing task from the host apparatus via the communication interface;
configure the working mode of the data processing engine based on the task descriptor after the execution of the data processing task is triggered;
control transmission of the operation data corresponding to the data processing task from the host apparatus to the data processing engine via the communication interface; and
control transmission of the data processing result from the data processing engine to the host apparatus via the communication interface, after the data processing engine has completed the processing of the operation data and generated the data processing result.

2. The task processing apparatus of claim 1, wherein the task descriptor at least contains information indicative of: a type of a data processing task, a storage location of operation data corresponding to a data processing task, and a storage location of a data processing result generated after the processing of a data processing task is completed.

3. The task processing apparatus of claim 2, wherein the at least one scheduler is further configured to:
configure the working mode of the data processing engine according to the information of the type of the data processing task;
control acquisition of the operation data from a memory of the host apparatus based on the information of the storage location of the operation data, and
transmit the data processing result to the memory of the host apparatus based on the information of the storage location of the data processing result.

4. The task processing apparatus of claim 2, wherein the task descriptor further contains information indicative of an operation command required for executing a data processing task; and the at least one scheduler is further configured to acquire the operation command from a memory of the host apparatus based on the information of the operation command.

5. The task processing apparatus of claim 1, wherein the task processing apparatus comprises a plurality of schedulers, and the controller is further configured to poll the plurality of schedulers to query whether there is a data processing task to be executed in the plurality of schedulers.

6. The task processing apparatus of claim 1, wherein the at least one data processing engine comprises a plurality of data processing engines, and the scheduler is further configured to select a specific data processing engine from the plurality of data processing engines according to the task descriptor to execute the data processing task corresponding to the task descriptor.

7. The task processing apparatus of claim 1, further comprising:
an input buffer and an output buffer corresponding to the data processing engine, wherein the input buffer is configured to buffer operation data, and the output buffer is configured to buffer data processing results.

8. The task processing apparatus of claim 1, wherein the scheduler is implemented as a hardware circuit.

9. A task processing system, comprising:
a host apparatus; and
at least one task processing apparatus coupled to the host apparatus via a communication interface to perform task and data interaction with the host apparatus;
wherein the host apparatus is configured to:
receive a data processing task from a user program executed on the host apparatus;
allocate the data processing task to a virtual function queue;
generate a task descriptor corresponding to the data processing task according to a type of the data processing task;
transmit the task descriptor to the at least one task processing apparatus for execution; and
receive from the at least one task processing apparatus a data processing result generated after operation data is processed;
wherein the task processing apparatus comprises:
a controller configured to query whether there is a data processing task to be executed in the task processing apparatus and trigger execution of the data processing task if the data processing task exists;
at least one data processing engine configured to process operation data corresponding to the data processing task according to a configured working mode, and generate a data processing result; and
at least one scheduler configured to:
receive a task descriptor of the data processing task from the host apparatus via the communication interface;
configure the working mode of the data processing engine based on the task descriptor after the execution of the data processing task is triggered;
control transmission of the operation data corresponding to the data processing task from the host apparatus to the data processing engine via the communication interface; and
control transmission of the data processing result from the data processing engine to the host apparatus via the communication interface, after the data processing engine has completed the processing of the operation data and generated the data processing result.

10. A task processing method executable by a scheduler in a task processing apparatus, the method comprising:
receiving a task descriptor of a data processing task from a host apparatus via a communication interface;
configuring a working mode of the data processing engine based on the task descriptor after the execution of the data processing task is triggered;
controlling transmission of operation data corresponding to the data processing task from the host apparatus to the data processing engine via the communication interface; and
controlling transmission of a data processing result from the data processing engine to the host apparatus via the communication interface, after the data processing engine has completed the processing of the operation data and generated the data processing result.

11. The task processing method of claim 10, wherein the task descriptor at least contains information indicative of: a type of a data processing task, a storage location of operation data corresponding to a data processing task, and a storage location of a data processing result generated after the processing of a data processing task is completed.

12. The task processing method of claim 11, wherein:
configuring the working mode of the data processing engine based on the task descriptor comprises: configuring the working mode of the data processing engine according to the information of the type of the data processing task;
controlling the transmission of the operation data corresponding to the data processing task from the host apparatus to the data processing engine via the communication interface comprises: accessing a memory of the host apparatus based on the information of the storage location of the operation data to acquire the operation data; and
controlling the transmission of the data processing result from the data processing engine to the host apparatus via the communication interface comprises: transmitting the data processing result to the memory of the host apparatus based on the information of the storage location of the data processing result.

13. The task processing method of claim 11, wherein the task descriptor further contains information indicative of an operation command required for executing the data processing task; and the task processing method further comprises:
acquiring the operation command from a memory of the host apparatus based on the information of the operation command.

14. The task processing method of claim 10, wherein the task processing apparatus comprises a plurality of data processing engines; and the task processing method further comprises:
selecting a specific data processing engine from the plurality of data processing engines according to the task descriptor to execute the data processing task corresponding to the task descriptor, before configuring the working mode of the data processing engine based on the task descriptor.

15. The task processing method of claim 10, wherein the scheduler is implemented as a hardware circuit.
